(19) United States
(12) Patent Application Publication
(10) Pub. No.: US 2005/0060187 A1
(43) Pub. Date: Mar. 17, 2005

(54) Patient information management system for clinical evaluation and content delivery

(76) Inventor: Janell M. Gottesman, St. Louis Park, MN (US)

Correspondence Address: MEDTRONIC, INC., 710 MEDTRONIC PARKWAY NE, MS-LC340, MINNEAPOLIS, MN, 55432-5604, US

(21) Appl. No.: 10/650,569

(22) Filed: Aug. 28, 2003

(51) Int. Cl. G06F 17/60

(52) U.S. Cl. 705/2

(57) ABSTRACT

Remote medical evaluations are coordinated through a central party that provides secure access to both caregivers and patients. Information is gathered from patients including those with IMD's and chronic diseases, and provided to physicians for diagnosis. Based on the diagnosis, specific educational content is selected. The diagnosis, patient instructions and the educational content are then provided to the patient. Thus, caregivers are able to conduct and bill for remote evaluations and patients receive relevant and timely information related to their condition.

### FIELD OF THE INVENTION

The present invention relates to a system and method for collecting and providing content based medical and related information to patients, caregivers and interested third parties upon predetermined conditions. More specifically, the present invention relates to a system and method for providing relevant medical and educational information to patients and to facilitating remote medical visits.

### DESCRIPTION OF THE RELATED ART

As medical services become ever more complex, patient demand for information related to their therapy, medical history, disease state, physiological states and conditions including treatment options has increased greatly. Likewise, the knowledge base of the medical community is rapidly increasing in both complexity and volume. Thus, patients may be faced with an information overload and may find it difficult to find the best and most relevant information that is specifically tailored to their particular needs. General searches of Internet based materials or traditional print sources make it difficult to find the particularly desired information at the right degree of specificity. Furthermore, patients new to a given condition or treatment option may not even know what they should be looking for within such information sources.

Medical personnel are likewise faced with a similar dilemma. One would expect caregivers to be more familiar with the conditions and treatment options, but in order to share this knowledge they would be required to spend far too much time educating individual patients. In the current health care environment, such tutelage is simply not practical. As a further complicating factor, technological advances are facilitating remote patient evaluations and services. Thus, the direct communication or face time between a caregiver and a patient is often greatly reduced or even eliminated. Furthermore, it may be difficult for a caregiver to account for time or seek reimbursement for time spent in educating patients.

Self-management by a patient of a given condition can provide for a more effective course of treatment. Success often depends upon providing the right educational material to the patient; however, another important factor is providing the right material at the right time. As a patient's condition progresses or changes, variations in treatment may be required. Thus, if a patient is given materials, for example, relating to the complete treatment of a complex condition over time, the patient may be overwhelmed and unable to process all of the information. Furthermore, they may not recognize what information is relevant or important at the current time.

### BRIEF SUMMARY OF THE INVENTION

Remote medical evaluations are coordinated through a central party that provides secure access to both caregivers and patients. Information is gathered from patients and provided to physicians for diagnosis. Based on the diagnosis, specific educational content is selected. The diagnosis, patient instructions and the educational content are then provided to the patient. Thus, caregivers are able to conduct and bill for remote evaluations and patients receive relevant and timely information related to their condition.

The present invention, in one embodiment, is a system comprising a central manager having a database with access to medical educational content for patients. The system also includes a patient portal to the central manager for gathering information. Also included is a physician portal to the central manager for providing the gathered information, obtaining diagnostic information, wherein the central manager retrieves selected educational content for delivery through the patient portal based on the diagnostic information.

In another embodiment, the present invention is a system comprising means for gathering patient information. The system also includes means for providing the patient information to a physician and receiving a diagnosis based on the information, and means for generating an information collection deliverable to a patient.

The present invention also includes a method for conducting remote medical evaluations. The method comprises receiving medical information from a patient through a patient portal into a central server and providing the medical information to a physician through a physician portal that is in communication with the central server. The method also includes receiving diagnostic information through the physician portal from the physician based on the medical information, identifying educational content relevant to the diagnostic information, and providing the diagnostic information and educational content through the patient portal.

The present invention also includes a method for conducting remote medical evaluations. The method comprises accessing a physician portal linked with a central manager, receiving patient medical information including IMD data through the physician portal from a patient, and evaluating the patient medical information. The method further includes rendering a diagnosis, selecting educational content for delivery to the patient, sending the diagnosis and the educational content through the physician portal to the patient, and billing for the remote medical evaluation.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a schematic illustration of a central manager interconnecting a patient with a physician.

FIGS. 2-8 are flowcharts illustrating the processes of the present invention.

### DETAILED DESCRIPTION

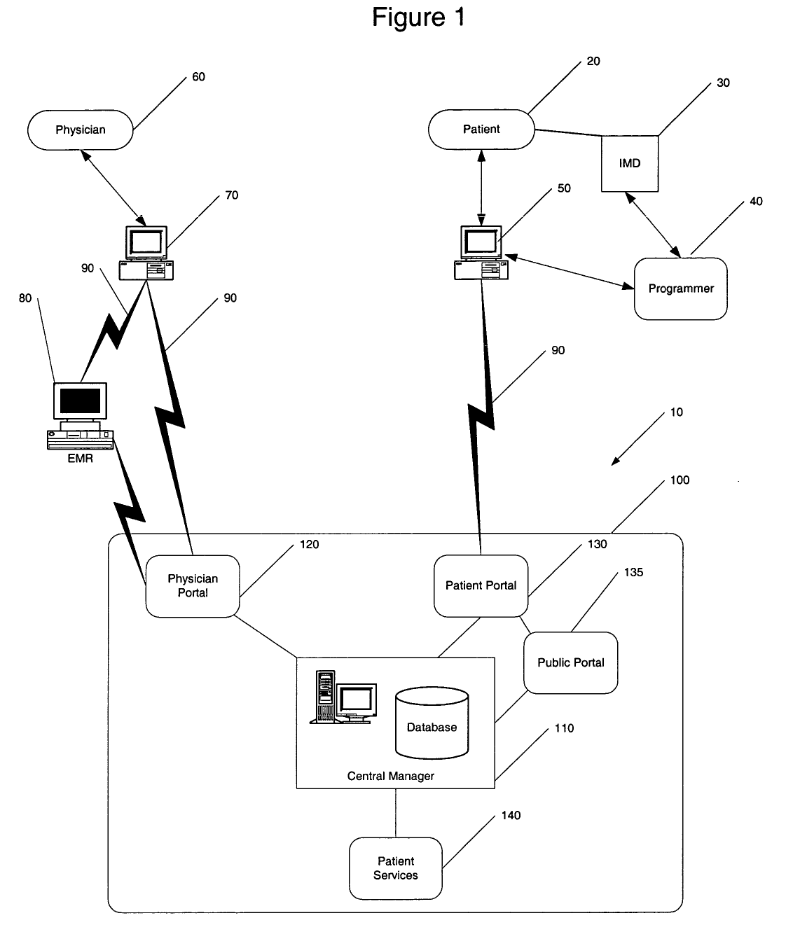

FIG. 1 is a schematic illustration of a system 10 interconnecting a remote patient 20 with a physician 60, through a central manager 110. In certain embodiments, patient 20 has an implantable medical device (IMD) 30. As such, central manager 110 may be a manufacturer of the device, providing both information content and a nexus with physicians 60 or other caregivers. System 10 is equally applicable to patients 20 who do not have an implantable medical device.

System 10 allows the patient 20 to provide information to the physician 60, such as, for example, answers to a questionnaire and data from the IMD 30. The physician then evaluates this information, performing an electronic or “e-visit” with the patient 20. The physician 60 then uses the system 10 to pull together appropriate educational content, or a regiment, generate instructions for the patient 20, generate pharmacological prescriptions, and advise the patient 20 and other caregivers of follow up steps. The system 10 also adds this information to the patient's medical records. In this manner, the system 10 provides a basis for the physician to conduct a genuine “E-visit” for insurance and billing purposes.

System 10 provides a communication medium, such as a website that permits the relevant parties to gain access at appropriate levels. For example, patient 20 accesses the system 10 through portal 130. More particularly, patient 20 utilizes a communications device 50, such as a personal computer, telephone, facsimile machine, PDA, cell phone, pager or the like to interconnect with portal 130 through communications medium 90. Communications medium 90 in one embodiment is the Internet. Alternatively, communications medium 90 may be a local area network (LAN), wide area network (WAN), telephone line, satellite communications link, cellular communications link, digital network link, or the like. Similarly, the physician 60 accesses a physician portal 120 via communications device 70. Central manager 110 also provides a public portal 135 that may be generally accessed by anyone. Central manager 110 maintains security so that only authorized persons are permitted to access specific information.

For each patient 20, an electronic medical record (EMR) 80 is maintained. EMR 80 is an electronic patient file containing the relevant personal and medical data used to monitor, diagnose, evaluate and treat the patient 20. EMR 80 may be maintained by the physician 60, a particular clinic, hospital, insurance agency, central manager 110 or by the patient 20 themselves. Preferably, the patient 20 will have only one EMR 80 that is accessed by any physician 60 or caregiver treating or otherwise interacting with patient 20. More commonly, each institution (e.g., hospital, clinic, doctor) will have a separate EMR 80 for a given patient 80.

In one embodiment, the system 10 performs several high level functions. That is, the system 10 provides a secure platform to allow the patient 20 to exchange information with the physician 60. It also provides a library or repository of educational material (or a link to such a information) so that the appropriate, specifically selected educational material can be packaged. Such packaging can occur in an automated fashion based on the physician's diagnosis (e.g., diagnostic codes such as International Classification of Disease or ICD-9) and/or based on specific material selected by the physician 60. In addition, the central manager 110 provides its own source of information and access to local experts. For example, as a manufacture of implantable medical devices, central manager 110 will have access to the most current data related to those devices, the conditions being treated, and expert personnel who can assist in diagnosing or troubleshooting issues. In conjunction with such services, the central manager 110 will have a patient services unit represented as patient services portal 140. Patient services will assist in gathering data from patient 20. For example, the patient 20 will uplink through patient portal 130 and provide data (e.g., through telemetry with a programmer 40) from the IMD 30. The physician may then access this data in a raw form or after some analysis or interpretation by patient services.

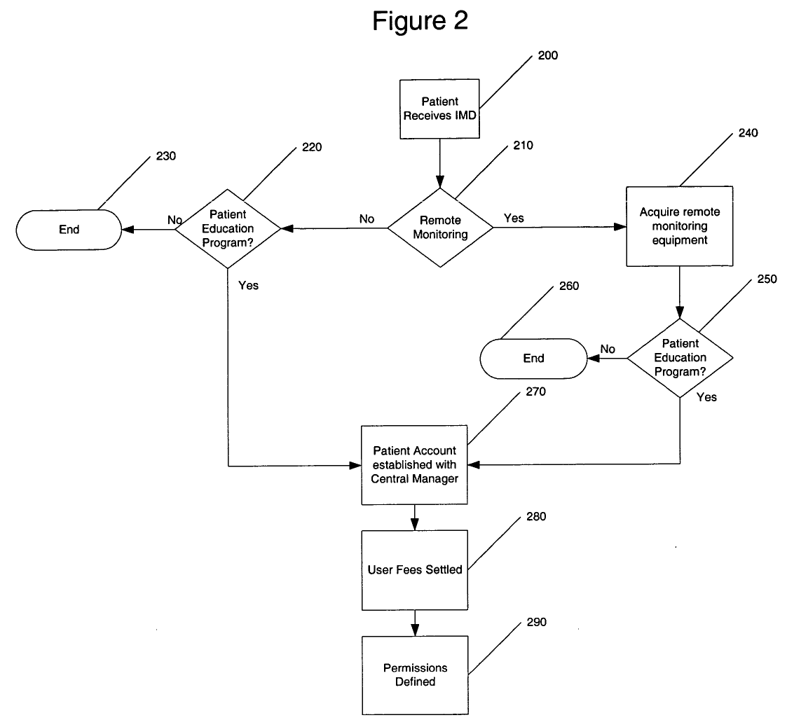

FIG. 2 is a flow chart illustrating one embodiment of the present invention. The processes described herein reside in the hardware and software components of the various entities of the system 10. For illustrative purposes, this embodiment is described with respect to a patient 20 having an IMD 30. As is known, information can be uplinked from the IMD 30 (through a programmer TM 40, home monitor such as the Medtronic CareLink™, or similar means) and analyzed. Such an analysis may include an evaluation of the performance of the device and/or monitoring various physiological parameters of the patient 20, among other things. In such a case, the uplinked information can be used by the physician 60, alone or in combination with other patient information, to conduct the remote examination/evaluation of the patient. In other embodiments, the patient may not have such an IMD 40 and the physician's evaluation is then based on other data that is implemented consistent with the other aspects and functions of the present invention.

The patient 20 receives the IMD 30 at step (200). As an option, the patient 20 may elect to participate in a remote monitoring program (210). Such programs are typically administered by the device manufacturer, which may correspond to the central manager 110. With such a program, the patient 20 uses a home monitor (240) to interrogate the IMD 30 and retrieve the data. The home monitor may be provided as a courtesy by the central manager 110 or may be provided for a fee. The data is then sent, typically over a telephone line, to the patient services group for evaluation. As this program is usually optional, the patient 20 may elect to forgo participation. If so, the patient is given the option of participating in the patient education program (220). If the patient elects not to participate, the process is terminated (230). If the patient participates in the patient educational program without participating in the home monitoring program, the patient will either be evaluated without the benefit of data from the IMD or the patient will make other arrangements to provide that information. For example, the patient could visit a health care provider for the purpose of interrogating the device and providing the data to the system 10. Afterwards, the patient would participate in the same manner herein described.

Similarly, a patient electing to participate in remote monitoring (210) may choose to not participate in the patient education program and if so, the process is terminated at (260).

Once a patient 20 elects to participate in the program, a patient account (270) is established allowing the patient access through the portal 130. That is, the central manager 110 creates an account for the patient 20, generating passwords or otherwise providing security. Likewise, an account for the physician 60 is either newly created (thereby providing portal 120) or modified to link the new patient 20 with a preexisting account.

At (280) the user fees are settled. While shown at this specific point in the process, the issuance and collections of fees or billing may occur at different points, depending upon the model chosen. Various options exist for billing arrangements. For example, enrollment (as defined by establishing an account at (270)) may require a subscription fee, paid to the physician 60 by the patient 20. In addition, the physician may pay fees to the central manager 110. As will be described in greater detail, the physician 60 performs various affirmative actions throughout the process. As such, the physician 60 may generate bills at one or more of these points and submit them to the patient 20 and/or the insurance provider. For example, bills may be generated when the physician 60 reviews the patient's information (e.g., questionnaire); when the physician reviews the complete set of information, thus conducting a complete e-visit; when the physician 60 issues instructions/diagnosis to the patient 20; when the EMR is updated; and/or at other appropriate intervals.

The accounts established for both the physician 60 and the patient 20 may have user selectable permissions defined (290). That is, each party may designate other parties that can access all or specific portions of the relevant portal. For example, the physician 60 may want certain staff members (e.g., nurses, administrative personnel, etc.) to be able to access the site. Likewise, the patient 60 may wish to provide other family members with access. Thus, each party can define who else may have access and to what level that access is granted.

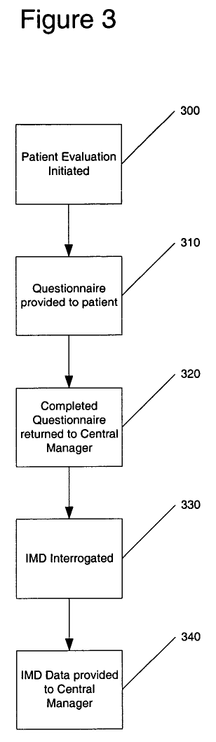

FIG. 3 is a flowchart illustrating the process of acquiring patient information. To begin with, the patient evaluation is initiated (300). Typically, this action is initiated by the physician or at the physician's request. Alternatively, the evaluation may proceed based on a predefined scheduled (e.g., every 6 months), based on a request from the patient, based on a request from the central manager 110, or in response to an external event (e.g., a medical emergency or episode).

Once the evaluation is initiated, a questionnaire is provided (310) to the patient 60. In one embodiment, notification is provided to the patient 20 to initiate the response. The patient then accesses the patient portal 130 and completes the questionnaire. Alternatively, the questionnaire can be emailed directly to the patient or provided in another manner. The questionnaire requests a medical history from the patient 20 and requests answers to many of the same questions that would be asked during a face to face appointment. The questionnaire requests information, for example, about current activities, general health, symptoms, current medication, problems, concerns, and the like.

The patient 20 completes the questionnaire and returns (320) it to the central manager 320. If completed through the patient portal 130, the information is simply stored by the central manager 110. Alternatively, the completed information may be transmitted via email and again stored. Other means, such as faxing a document, may be employed, in which case the information is entered into an electronic format through scanning or data entry. Data is collected (330) from the IMD (if applicable) and provided (340) to central manager 110. It does not matter whether the IMD data is collected before or after the questionnaire is submitted, so long as they are sufficiently temporally proximate to be medically relevant.

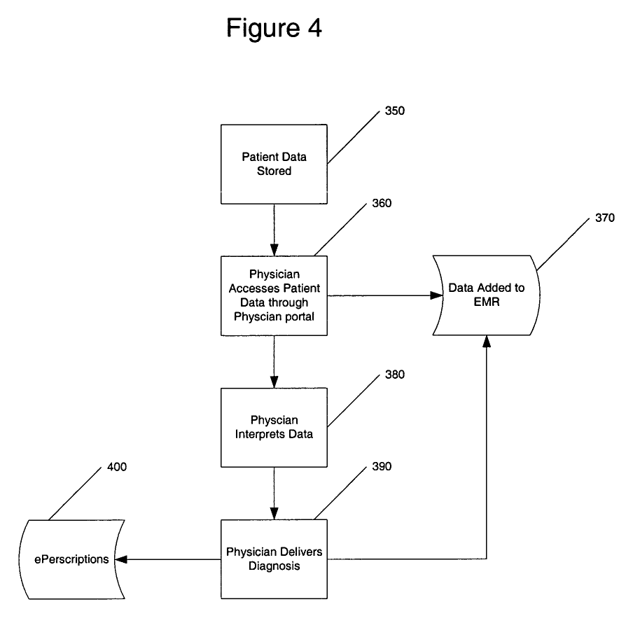

Referring to FIG. 4, the data collected from the patient is stored (350) within a database at the central manager 110. Subsequently, the physician accesses (360) the physician portal 120 and reviews the information. As appropriate, the information reviewed may be directly added to the patient's EMR (370). That is, certain raw data may be added to the EMR based on standard practice (e.g., automatically added) or added based on the physician's request. The physician then analyzes (380) the data and comes to a conclusion. The resulting diagnosis and/or instructions are generated and delivered. This information is stored in the EMR (370). If prescriptions are provided by the physician, they may be automatically processed through participating pharmacies via an electronic prescription process (400). Alternatively, a prescription is ultimately provided to the patient and the patient has the prescription filled.

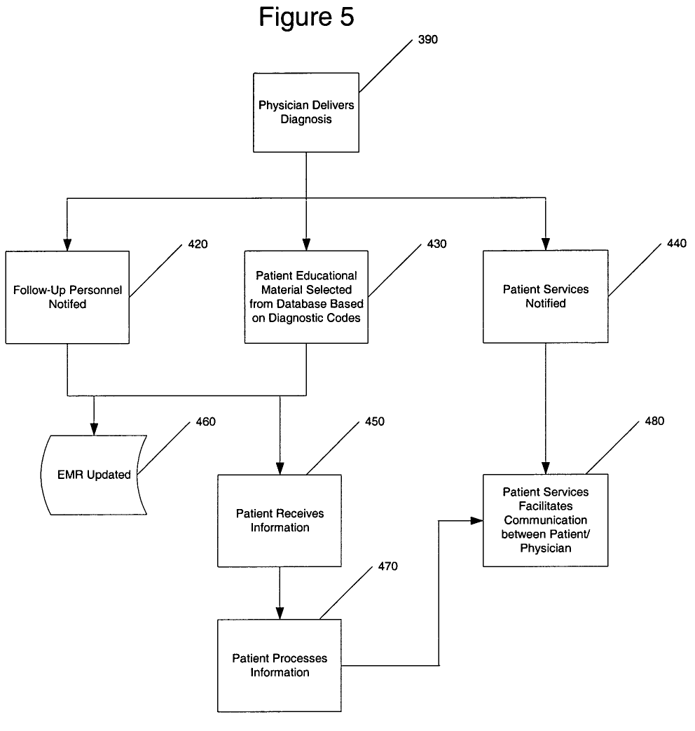

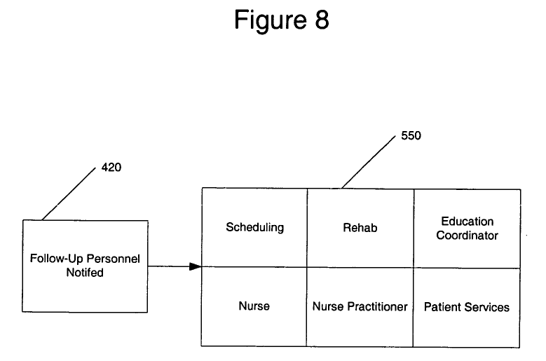

FIG. 5 is a flowchart that illustrates the step (390) of delivering the diagnosis in greater detail. As a result of the diagnosis, various follow up actions may be required and as such, personnel relevant to those actions are notified (420). For example, a follow-up appointment, testing, or examination may be required and an electronic communication may be sent to the administrative staff to arrange the required procedures. As another example, the IMD may need to be adjusted or replaced. Therefore, a procedure to reprogram the device may be scheduled or a procedure may be scheduled to surgically replace all or a portion of the device. Of course, the range of possible follow-up activities can vary from very simple to very complex and the parties notified will vary accordingly. FIG. 8 illustrates some of the possible follow-up personnel that may be notified. The EMR is updated (460) as appropriate.

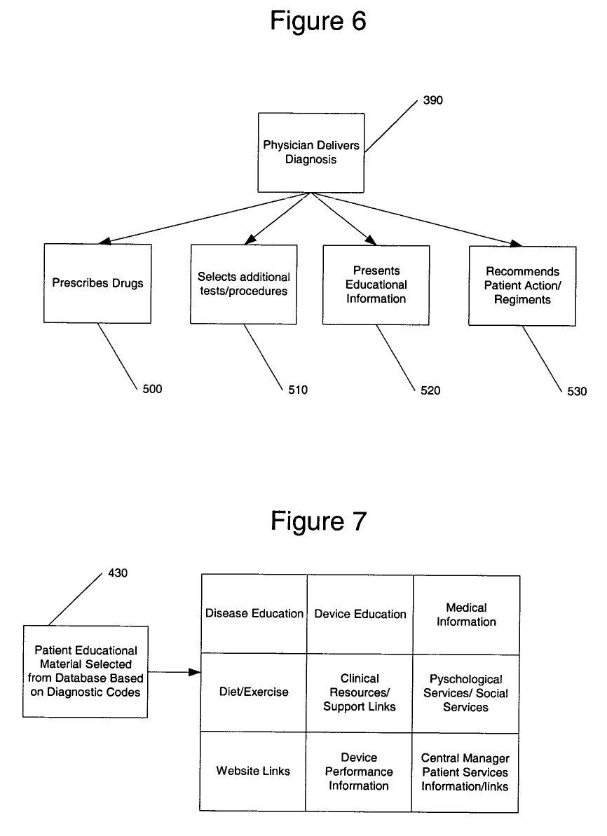

FIG. 6 is a flowchart that illustrates in greater detail some of the particular actions the physician 60 may take when making and delivering (390) the diagnosis. For example, certain medications may be prescribed (500), additional tests and procedures may be selected (510), the educational content is acquired (520), and specific recommendations for the patient may be made (530).

Once the diagnosis is generated, the physician 60 (or an appropriate delegate) selects and acquires (430) the appropriate educational material to be provided to the patient. In many instances, the providing of such information may be the only action taken based upon a diagnosis. The information provided is specifically tailored to the patient's immediate needs. For example, a given patient's current disease state may require a particular diet and exercise regime, activity restrictions, monitoring requirements, or similar protocols. Likewise, a tailored explanation of the current disease state, in and of itself, will provide the patient a sense of understanding. The educational content can be extracted from central manager 110 and various resources linked thereto. The physician may select specific content manually and/or system 10 automatically generates and constructs applicable content based on the indicated diagnosis. For example, the system 10 could identify potentially relevant education material based on a diagnosis code, such as the ICD-9 protocol. The EMR is updated (460) as appropriate.

Providing information to the patient that is both relevant in content and in time relative to the patient's current condition prevents patient overload, promotes efficiency and makes the content user-friendly. Typically, when a patient is initially diagnosed or treated, all available information about the condition or treatment could be given or communicated to the patient. However, this can be quite overwhelming and the patient could easily overlook important information or may fail to appreciate how things change as the condition progresses. This is particularly germane to patients with chronic disease including long-term medical care and follow-up. Thus, the information provided delivers not only relevant information, but information at the relevant time. In other words, the patient is given what they need, when they need it without an overload of information. This deliverable arrangement if information is referred to as an information collection.

In addition to notifying the follow up personnel (420), the diagnosis may require a notification to patient services (440). For example, if the IMD is to be reprogrammed, patient services may undertake that task.

The physician's instructions, comments, and education material are assembled and stored within central manager 110 for subsequent access by the patient 20. The patient 20 then accesses (450) patient portal 130 and reviews (470) the same. Any follow-up questions the patient may have are routed (480) through patient services 140 and subsequent communication and, if necessary, analysis is generated. At this point, the patient implements the physician's instructions and gains a better understanding of their disease state or condition and their course of treatment based on the specific educational content provided. The information can be reviewed and processed and links to additional resources can be provided for supplemental information, if desired by the patient.

FIG. 7 illustrates some of the types of information that may be gathered for an information collection. This information can be pulled from databases within the central manager 110 or can be accessed via links to other remote sites providing such content. The provided information collection may also provide links (either to locations within central manager 100 or remote sites) that allow patients to follow up and gather additional or more in-depth information.

In addition to facilitating the interaction between the physician and the patient, the central manager can also provide useful information to the physician through the portal 120. For example, medical device performance reports, safety alerts, advisory information, warranty information, training information and other information related to the medical devices and other types of products offered by the manufacturer can be provided. This allows those responsible for the use of the medical devices/products to get the best and most current information about the products directly from the manufacturer in a timely manner. In addition, as the physician will be using the portal 120 for access to patient data, they will already be conveniently linked with this additional resource.

Further, as the portal 120 is a tool that physician's will use routinely to gain access to patient data, the portal 120 can be made even more useful by providing customer loyalty links. That is, by providing links, access, or portions from other relevant sources, the portal 120 becomes a broad based tool for other purposes. For example, links to other information providers can be included such as other manufacturers public information, web sites such as WebMD, news sources, information sources specific to the physicians area of practice, research sites/publication, best practices, and links to training, conference and event schedules. All of this information can be referred to as “customer loyalty information”. That is, information intended to make use of the physician portal more attractive and invite more frequent usage beyond the usual interaction with the patient and diagnosis database.

At the same time, similar customer loyalty services and information can be provided through the patient portal 130 and the public portal 135. For example, links to content relevant to patients (in general or specifically selected based on specific or generic patient profiling), profiles of new technology, market research, clinical studies (results and requests for participation), support groups, relevant local news, and similar information and links can be provided.

In addition, data specific to the patient can be accessed. For example, as IMD data is up-linked some or all of this data is made available to the patient. Alternatively, such data can be provided in an explanatory context with some degree of analysis provided. A patient with a pacemaker-cardioverter-defibrillator may be able to view episodes or arrhythmia, or the timing of past defibrillation pulses, for example.

Although the present invention has been described with reference to preferred embodiments, persons skilled in the art will recognize that changes may be made in form and detail without departing from the spirit and scope of the invention.

1. A system comprising:
a central manager having a database with access to medical educational content for patients;
a patient portal to the central manager for gathering information; and
a physician portal to the central manager for providing the gathered information, obtaining diagnostic information, wherein the central manager retrieves selected educational content for delivery through the patient portal based on the diagnostic information.

2. The system of claim 1, wherein the gathered information includes performance data from an IMD.

3. The system of claim 1, wherein the central manager retrieves the selected educational content based on a diagnostic code.

4. The system of claim 1, wherein the central manager retrieves the selected educational content based on physician instructions received through the physician portal.

5. A system comprising:
means for gathering patient information;
means for providing the patient information to a physician and receiving a diagnosis based on the information; and
means for generating an information collection deliverable to a patient.

6. A method for conducting remote medical evaluations, the method comprising:
receiving medical information from a patient through a patient portal into a central server;
providing the medical information to a physician through a physician portal that is in communication with the central server;
receiving diagnostic information through the physician portal from the physician based on the medical information;
identifying educational content relevant to the diagnostic information; and
providing the diagnostic information and educational content through the patient portal.

7. The method of claim 6 further comprising:
receiving a request through the physician portal to conduct a remote evaluation with the patient from a physician;
providing a medical questionnaire to the patient; and
receiving the completed questionnaire from the patient as part of the medical information.

8. The method of claim 7, further comprising:
receiving device data from an IMD implanted within the patient, wherein the device data forms part of the medical information.

9. The method of claim 6, further comprising
generating an electronic prescription as part of the diagnostic information; and
transmitting the electronic prescription to a pharmacy.

10. The method of claim 6, wherein the educational content includes one or more topics selected from the group: disease education, medical device education, general medical information, diet, exercise, or clinical resources.

11. The method of claim 6, further comprising:
providing an electronic medical record correlated to the patient; and
updating the electronic medical record based on the diagnostic information.

12. The method of claim 6, further comprising providing instructions through the physician portal to follow up personnel based on the diagnostic information.

13. The method of claim 6, wherein the educational content is identified based on diagnostic codes.

14. The method of claim 6, further comprising providing customer loyalty information through the physician portal.

15. A method for conducting remote medical evaluations, the method comprising:
accessing a physician portal linked with a central manager;
receiving patient medical information including IMD data through the physician portal from a patient;
evaluating the patient medical information;
rendering a diagnosis;
selecting educational content for delivery to the patient;
sending the diagnosis and the educational content through the physician portal to the patient; and
billing for the remote medical evaluation.

16. The method of claim 15, further comprising notifying additional personnel of follow-up activities for the patient through the physician portal.

17. The method of claim 15, further comprising updating an electronic medical record corresponding to the patient.

18. The method of claim 15, further comprising generating an electronic prescription.

19. The method of claim 15, wherein the educational content is selected based on suggested information received from the central manager.

20. The method of claim 19, wherein the suggested information is generated based on diagnostic codes.
